(19) United States
(12) Patent Application Publication
(10) Pub. No.: US 2010/0156513 A1
(43) Pub. Date: Jun. 24, 2010

(54) CHARGE PUMP

(75) Inventors: Horacio Saldivar, Canoga Park, CA (US); Thomas A. Hertel, Santa Clarita, CA (US); Erich H. Soendker, Granada Hills, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: PRATT & WHITNEY ROCKETDYNE, INC., Canoga Park, CA (US)

(21) Appl. No.: 12/342,765

(22) Filed: Dec. 23, 2008

(51) Int. Cl. G05F 1/10

(52) U.S. Cl. 327/536

(57) ABSTRACT

A high power DC-DC converter uses wide bandgap semiconductor switches and capacitors as a charge pump to convert a DC input to a DC output of a different potential. Each capacitor is connected to the output of one of the stages of the charge pump. A wide bandgap semiconductor switch is connected between the input and output of each stage, and the conductive state of the switch is controlled by a circuit that compares voltage at the input and output of the stage. A multiphase drive alternates drive voltage applied to the capacitors to cause charge to be passed from stage-to-stage through the charge pump.

### BACKGROUND

The present application relates to high power electrical circuitry. More particularly, the application relates to a DC-DC converter capable of producing kilowatt range DC output power.

DC-DC converters are used to convert input DC power to output DC power at a different potential level. The DC output power may have the same or opposite polarity and may have either a higher or lower potential than the input DC power.

High power DC-DC converters can require operation at elevated temperatures. Electrical circuits using silicon semiconductor devices are generally limited to temperatures up to about 125° C. At higher temperatures, charge can leak across PN junctions of silicon devices. Even at temperatures below 125° C., silicon devices that require high power dissipation require a heat sink or active cooling systems, or both, in order to protect the devices from being damaged. Heat sinks and active cooling systems take up space and add weight.

One commonly used type of DC-DC converter converts the input power from DC to AC, and then convert the AC power back to DC at a different potential and/or polarity. Transformers also add volume and weight to the DC-DC converter.

There is a continuing demand for electronic circuits that are smaller in size and have fewer components.

### SUMMARY

A multistage charge pump converts a DC power input to a DC power output of a different potential by transferring charge from stage-to-stage. Each stage of the charge pump includes an input, an output, a wide bandgap semiconductor switch connected between the input and output, a charge storage capacitor having one terminal connected to the output, and a switch control circuit that controls the conductive state of the switch as a function of potential unbalance between the input and output of the stage. A multiphase driver applies alternating potential drive signals to the other terminal of each capacitor to cause charge to be transferred sequentially from stage-to-stage between the DC power input and the DC power output.

### BRIEF DESCRIPTION OF THE DRAWINGS

FIG. 1 is an electrical schematic diagram of a high power charge pump DC-DC converter.

FIG. 2 is an electrical schematic diagram of a high power charge pump DC-DC converter having additional charge transfer stages.

### DETAILED DESCRIPTION

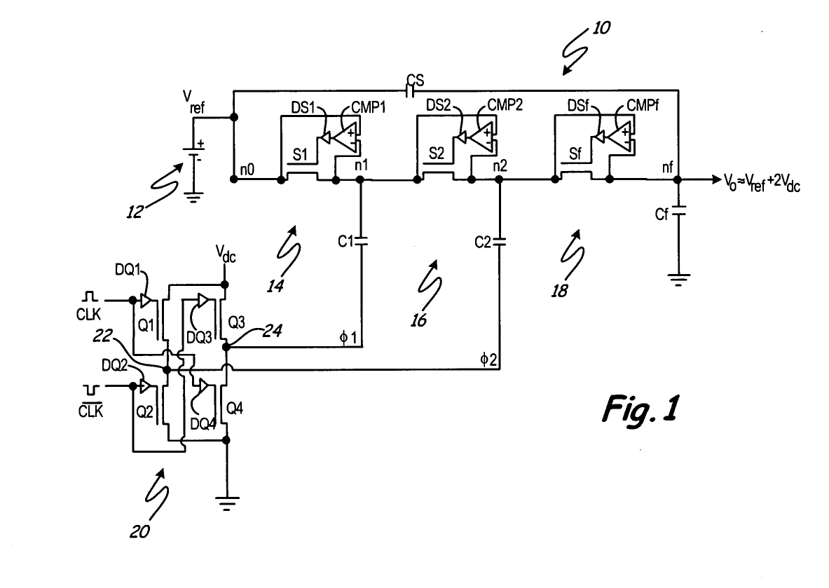

FIG. 1 shows charge pump 10, which converts an input voltage Vref to an output voltage Vo which is approximately equal to Vref+2Vdc. Charge pump 10 makes use of high temperature wide bandgap semiconductor switches of, for example, silicon carbide or gallium nitride. Charge pump 10 is capable of power conversion at the kilowatt level and can operate in a wide temperature range from, for example, about −200° C. to about 300° C.

Charge pump 10 includes input source 12, charge transfer stages 14, 16, and 18, H bridge driver 20, smoothing capacitor Cs, and final output capacitor Cf.

First stage 14 includes wide bandgap semiconductor switch S1, comparator CMP1, driver DS1, and capacitor C1. Switch S1 is normally an off semiconductor switch having first and second main current carrying electrodes connected to nodes n0 and n1, respectively. Comparator CMP1 has its positive (+) input connected to node n0 and its negative (−) input connected to node n1. When potential at node n0 exceeds potential at n1, comparator CMP1 provides an output to driver DS1, which in turn provides an input to the control electrode of switch S1 to cause switch S1 to turn on. Capacitor C1 has one terminal connected to node n1 and its other terminal connected to driver 20 to receive first phase drive signal φ1.

Second stage 16 includes wide bandgap switch S2, comparator CMP2, driver SD2, and capacitor C2. The main current carrying electrodes of switch S2 are connected to nodes n1 and n2. Comparator CMP2 senses the potential difference between nodes n1 and n2, and turns on switch S2 when the potential at node n1 exceeds the potential at node n2. Capacitor C2 has one terminal connected to node n2, and the other terminal connected to driver 20. C2 receives second phase drive signal φ2, which is the inverse of (i.e., 180° out of phase with) drive signal φ1.

Final stage 18 includes wide bandgap semiconductor switch Sf, comparator CMPf, driver DSf, and final or output capacitor Cf. The main current carrying electrodes of switch Sf are connected to nodes n2 and nf. Comparator CMPf senses potential difference between nodes n2 and nf, and causes switch Sf to turn on when the potential at node n2 exceeds the potential at node nf. Capacitor Cf has one terminal connected to node nf, and the other terminal connected to ground.

Driver 20 is an H bridge circuit formed by transistors Q1-Q4 and drivers DQ1-DQ4. In the embodiment shown in FIG. 1, transistors Q1-Q4 are shown as field effect transistors (FETs), although in other embodiments bipolar transistors and other transistors can be used. The drains of transistors Q1 and Q4 are connected to bus voltage Vdc. The source of Q1 is connected to the drain of Q2 at node 22, and the source of Q3 is connected to the drain of Q4 at node 24. The sources of Q2 and Q4 are connected to ground. Drive signal φ1 is produced at node 24 and drive signal φ2 is produced at node 22. In some cases, transistors Q1-Q4 of H bridge 20 may also be wide bandgap semiconductor transistors.

H bridge circuit 20 receives clock signals CLK and C̅L̅K̅ as inputs. Clock signal CLK is supplied to drivers DQ1 and DQ4, while clock signal C̅L̅K̅ is provided to drivers DQ2 and DQ3. Clock signals CLK and C̅L̅K̅ are high frequency 50% duty cycle signals. The clock frequency of signals CLK and C̅L̅K̅ may be, for example, on the order of 1 MHz.

When clock signal CLK goes high, transistors Q1 and Q4 turn on. At the same time, clock signal C̅L̅K̅ goes low, causing transistors Q2 and Q3 to turn off. As a result, node 22 is connected through transistor Q1 to Vdc, and node 24 is connected through Q4 to ground. Thus drive signal φ1 to capacitor C1 is at ground potential, and drive signal φ2 to capacitor C2 is at Vdc.

When CLK goes low and C̅L̅K̅ goes high, transistors Q1 and Q4 turn off and transistors Q2 and Q3 turn on. As a result, node 22 and drive signal φ2 go to ground potential. Node 24 and drive signal φ1 go to potential Vdc.

Input node n0 of charge pump 10 is connected to input voltage Vref. When φ1 switches from Vdc to ground, capacitor C1 causes the potential at n1 to decrease. As a result, the potential at node n0 exceeds the potential at node n11, and comparator CMP1 turns on switch S1. This allows charge to be transferred from node n0 to node n11, where it is stored on capacitor C1.

At the same time, the rise in drive signal φ2 from ground to Vref causes the potential at node n2 to exceed the potential at node n1. As a result, comparator CMP2 causes switch S2 to be turned off, and no charge transfer occurs between nodes n1 and n2 while drive signal φ2 is at Vdc.

The rise in potential at node n2 caused by drive signal φ2 going to Vdc causes the potential at node n2 to be higher than the potential at node nf. As a result, comparator CMPf turns on switch Sf, which allows charge to be transferred from node n2 to node nf, where it is stored at capacitor Cf.

When drive signal φ1 switches from ground to Vdc, the rise in potential at node n1 results in switch S1 being turned off by comparator CMP1. No charge transfer occurs between nodes n0 and n1 while drive signal φ1 is at Vdc.

At the same time, the rise in potential of n1 as a result of drive signal φ1 corresponds to a reduction in potential of node n2 as a result of drive signal φ2 going from Vdc to ground. As a result, the potential at node n1 exceeds the potential at node n2, and comparator CMP2 turns on switch S2. Charge is then transferred from capacitor C1 to capacitor C2 through switch S2.

With φ2 at ground, the potential at node nf exceeds the potential at node n2. As a result, switch Sf is turned off by comparator CMPf.

The cycling of drive signals φ1 and φ2 continues, with charge being transferred from node n0 to n1 and from node n2 to nf during one half of the drive cycle, and charge being transferred from node n1 to n2 during the other half of the drive cycle. The resulting output voltage Vo at node nf is≈Vref+2Vdc, less voltage loss occurs across switches S1, S2, and Sf and switches Q1-Q4 when they are turned on. Because these voltage drops are very small, output voltage Vo is≈Vref+2Vdc.

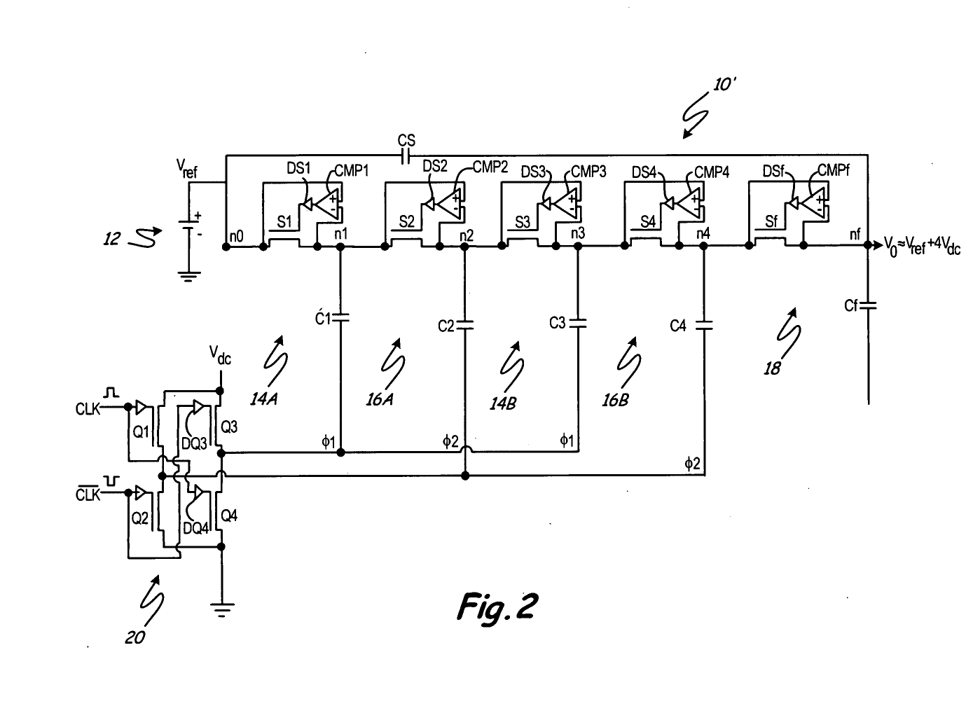

A larger increase from input voltage Vref to output voltage Vo can be achieved by adding additional pairs of charge transfer stages. FIG. 2 shows charge pump 10′, which is generally similar to charge pump 10 of FIG. 1, except that first stage 14A and third stage 14B are driven by drive signal φ1, while second and fourth stages 16A and 16B are driven by drive signal φ2.

Third stage 14B includes wide bandgap semiconductor switch S3, comparator CMP3, driver DS3, and capacitor C3. Similarly, fourth stage 16B includes wide bandgap semiconductor switch S4, comparator CMP4, driver DS4, and capacitor C4. Third stage 14B is connected to nodes n2 and n3, while fourth stage 16B is connected to nodes n3 and n4. Final stage 18 is connected between node n4 and node nf.

When drive signal φ1 is low (ground) and drive signal φ2 is high (Vdc), charge is being transferred from node n0 to node n1 through switch S1, from node n2 to node n3 through switch S3, and from node n4 to node nf through switch Sf. Switches S2 and S4 are turned off.

When drive signal φ2 is at Vdc and drive signal φ2 is at ground, switches S1, S3, and Sf are turned off and switches S2 and S4 are turned on. Charge transfer occurs from node n1 to node n2 through switch Sf and from node n3 to node n4 through switch S4. As drive signals φ1 and φ2 alternate back and forth between Vdc and ground, charges transferred in a bucket brigade type fashion from input node n0 to output node nf.

The output voltage produced by charge pump 10′ is equal to Vref+4Vdc minus voltage drops of switches S1-S4 and Sf. Since the voltage drop of each of the wide bandgap semiconductor switches in their on state is very low, Vo≈Vref+4Vdc.

A further increase in output voltage can be achieved by adding an additional pair of stages. With three stages driven by signal φ1 and three stages driven by signal φ2, output voltage Vo is≈Vref +6Vdc. Each additional pair of φ1 and φ2 driven stages adds approximately 2Vdc to the output voltage.

In one embodiment, capacitors C1, C2 . . . Cf are approximately 100 microfarad capacitors. Smoothing capacitor Cs has a higher capacitance, such as about 1000 microfarad.

The charge pump disclosed provides DC-to-DC conversion without the need for transformers or other inductors. As a result, a reduction in size and weight can be achieved. The capacitors used in the charge pump generally will consume less space, and weigh less than a transformer that may be used for a DC-DC converter comparable voltage power capability.

Operation at a higher temperature is possible with circuits that use silicon carbide semiconductor devices. Heat transfer from a body to its surrounding environment by thermal radiation is proportional to T⁴, where T is the body's temperature. By operating at a higher temperature, switches S1-Sf provide increased heat transfer. As a result, smaller, lighter heat sinks can be used, and active cooling systems may be reduced or eliminated. The charge pump of the present invention can handle voltages ranging from several hundred volts to the kilovolt range and power in the kilowatt range, in some cases exceeding 30 kilowatts of output power. This can be achieved while satisfying a demand for smaller size and a reduction in the number of components. Those skilled in the art will recognize that changes may be made in form and detail without departing from the spirit and scope of the disclosure.

1. A charge pump comprising:
a series of charge transfer stages, each stage comprising:
an input node;
an output node;
a wide bandgap semiconductor switch having first and second main current carrying electrodes and a control electrode, the first main current carrying electrode connected to the input node and a second main current carrying electrode connected to the output node;
a switch control circuit connected to the control electrode for controlling conduction between the first and second main current carrying electrodes as a function of potentials at the input node and the output node; and
a capacitor connected to the output node, and
a drive circuit for applying drive signals to the capacitors to cause charge to be transferred from the input node to the output node of each charge transfer stage.

2. The charge pump of claim 1, wherein the switch control circuit includes a comparator.

3. The charge pump of claim 2, wherein the comparator has a first input terminal connected to the input node and a second input terminal connected to the output node.

4. The charge pump of claim 3, wherein the comparator produces an output that causes the wide bandgap semiconductor switch to turn on when a potential at the first input terminal exceeds a potential at the second input terminal.

5. The charge pump of claim 1, wherein the wide bandgap semiconductor switch comprises a normally off transistor.

6. The charge pump of claim 5, wherein the switch control circuit turns on the normally off transistor when potential at the input node exceeds potential at the output node.

7. The charge pump of claim 1, wherein the drive signals comprise a first phase signal and a second phase signal that alternate between a first potential and a second potential.

8. The charge pump of claim 7, wherein the first phase signal and the second phase signal are 50% duty cycle signals, and the second phase signal is an inverse of the first phase signal.

9. The charge pump of claim 8, wherein the drive circuit comprises an H-bridge circuit that alternately switches the first and second phase signals between a supply voltage and ground.

10. The charge pump of claim 7, wherein the first phase signal is applied to the capacitor of a first charge transfer stage, and the second phase signal is applied to the capacitor of a second charge transfer stage, and wherein the output node of the first charge transfer stage is connected to the input node of the second charge transfer stage.

11. A charge pump comprising:
a charge pump input;
a charge pump output;
a series of charge transfer stages for transferring charge sequentially from a charge pump input and the charge pump output, each stage including:
a wide bandgap normally off transistor;
a control circuit for turning on the transistor to transfer charge based upon a potential unbalance between input and output nodes of the stage; and
a capacitor connected to the output node; and
a drive circuit for supplying drive signals that apply alternating potentials to the capacitors.

12. The charge pump of claim 11, wherein the series of charge transfer stages includes alternating first and second charge transfer stages.

13. The charge pump of claim 11, wherein the drive signals comprise a first phase signal and a second phase signal that switch between a first potential and a second potential.

14. The charge pump of claim 13, wherein each first charge transfer stage receives the first phase drive signal and each second charge transfer stage receives the second phase drive signal from the drive circuit.

15. The charge pump of claim 14, wherein the first phase signal and the second phase signal are 50% duty cycle signals, and the second phase signal is an inverse of the first phase signal.

16. The charge pump of claim 13, wherein the drive circuit comprises an H-bridge circuit that alternately switches the first and second phase signals between a supply voltage and ground.

17. The charge pump of claim 11, wherein when the drive signals apply the first potential to the capacitors, the control circuit turns on the wide bandgap normally off transistor, and when the drive signals apply the second potential to the capacitors, the control circuit turns off the wide bandgap normally off transistor.

18. The charge pump of claim 11, wherein the control circuit comprises a comparator having a first input terminal connected to the input node and a second input terminal connected to the output node.

19. The charge pump of claim 18, wherein the comparator produces an output that causes the wide bandgap normally off transistor to turn on when a potential at the first input terminal exceeds a potential at the second input terminal.

20. The charge pump of claim 11, wherein the wide bandgap normally off transistor comprises a SiC transistor.
